(19) United States
(12) Patent Application Publication
(10) Pub. No.: US 2010/0169143 A1
(43) Pub. Date: Jul. 1, 2010

(54) System and method for managing numerous facets of a work relationship

(76) Inventors: Peter Carr, Toronto (CA); Anne Carberry, Toronto (CA); Shaheen Chowdhury, Toronto (CA); Lisa Howarth, Brampton (CA)

Correspondence Address: MEREK, BLACKMON & VOORHEES. LLC, 673 South Washington Street, Alexandria, VA, 22314, US

(21) Appl. No.: 12/318,605

(22) Filed: Dec. 31, 2008

(51) Int. Cl. G06Q 10/00; G06Q 30/00; G06F 3/048

(52) U.S. Cl. 705/9; 705/32; 705/7; 715/845

(57) ABSTRACT

A system and method of managing numerous facets of work relationships. In a preferred form, the system provides end-to-end integration of the contract resourcing process (“requisition to check”) for a multitude of clients and a multitude of service providers.

### FIELD OF THE INVENTION

The present invention relates to systems and methods of managing a work relationship. More particularly, the present invention relates to systems and methods for managing work relationships between one or more clients and one or more service providers (e.g., contractors, vendors, sub-vendors, etc.).

### BACKGROUND OF THE INVENTION

For many years, entities in the service industries have employed manual time sheet and billing systems as a way for service providers to record time spent on a work activity and thereafter be paid for the work. In a typical example, a contractor may submit to a potential client an estimate of the cost for a particular job in terms of time and materials. If the client reaches agreement with the contractor on the terms, the contractor's time can be recorded so that the client can review and approve the time spent by the contractor in performing the work. Typically, the contractor will write or type onto a timesheet the amount of time the contractor has worked over the course of the contract, usually on a per time unit basis (e.g., hours per day). Depending upon the length of the contract, the contractor might regularly submit aggregated time sheets covering a predetermined period (e.g., one month) to the client for approval and payment. If the client approves the time spent by the contractor, the contractor can then draw up an invoice to provide to the client for payment. These manual systems suffer from numerous disadvantages.

Attempts have been made to automate the above procedure. For example, U.S. patent application Ser. No. 10/962,762 filed on Jun. 7, 2004 discloses a novel and unobvious automated system for managing the contract resourcing process from end-to-end (i.e., from requisition to hire). U.S. patent application Ser. No. 11/603,235 filed on Nov. 21, 2006 discloses another novel and unobvious automated system for managing the contract resourcing process from end-to-end (i.e., from requisition to hire). U.S. patent application Ser. No. 11/603,235 corresponds to U.S. Patent Application Publication 2008/0120152 the entire contents of both of these document is herein incorporated by reference, i.e., the U.S. Patent Application and the U.S. Patent Application Publication.

Preferred forms of the present invention seek to provide an even further advanced automated system for managing the contract resourcing process from end-to-end.

### OBJECTS AND SUMMARY OF THE INVENTION

An object of a preferred embodiment of the present invention is to provide an automated system for managing work relationships between one or more clients and one or more service providers (e.g., contractors, vendors, sub-vendors, etc.).

Another object of a preferred embodiment of the present invention is to provide an automated system for managing work relationships between one or more clients and one or more service providers that allows a client to readily create a plurality of different requisitions (e.g., job requisition that is submitted to one or more vendors to receive acceptable candidates to fill the requisition, direct source requisition that allow the client to identify a suitable candidate to fill the requisition without any involvement of a vendor and/or an extension requisition that allows a client to create a requisition for a contractor that is presently working for the client and whom the client wants to extend the employment of beyond the original contract period).

A further object of a preferred embodiment of the present invention is to provide an automated system for managing work relationships that allows a client to customize requisition field information to suit the client's unique business needs including but not limited to specifying the number of resumes that may be submitted, specifying the cost centre for the particular requisition, the acceptable billing rate or billing rate range and key individuals in the requisition approval and candidate hiring processes.

Yet another object of a preferred embodiment of the present invention is to provide an automated system for managing work relationships that restricts editorial accessibility to requisitions to the client initiator/manger to eliminate or reduce requisition errors.

Still yet another object of a preferred embodiment of the present invention is to provide an automated system for managing work relationships that allows the client to specify in the requisition key individuals in the requisition and hiring processes including the number and identity of one or more approvers that need to approve the requisition before it can be filled by a new candidate or a contractor presently working for the client, an alternate hiring manager that can take action in the event the initiator/manager is unavailable and/or the number and identity of interviewers that are to interview candidates to fill the requisition.

Still a further object of the present invention is to provide an automated system for managing work relationships automatically that allows a primary timesheet approver to designate and subsequently modify secondary timesheet approvers that can approve timesheets in the event that the primary timesheet approver is unavailable.

Yet still a further object of a preferred embodiment of the present invention is to provide an automated system for managing work relationships that allows users to generate numerous different reports providing data that is specific to the users needs.

It must be understood that no one embodiment of the present invention need include all of the aforementioned objects of the present invention. Rather, a given embodiment may include one or none of the aforementioned objects. Accordingly, these objects are not to be used to limit the scope of the claims of the present invention.

In summary, one preferred embodiment of the present invention is directed to an apparatus for managing time related work activities of at least one worker for at least one client including a computer system having a requisition module configured to track and manage procurement of labor resources for at least one client. The requisition module is further configured to allow a client user to create at least two of the following types of requisitions: (i) job requisition to be submitted to one or more vendors so that the client can procure the services of at least one worker for a position defined in the job requisition, (ii) a direct source requisition to allow the client to procure the services of at least one worker without any action by a vendor, and (iii) an extension requisition to allow the client to extend the employment of a worker presently providing services to the client.

Another preferred embodiment of the present invention is directed to an apparatus for managing time related work activities of at least one worker for at least one client. The apparatus includes a computer system having a requisition module configured to manage procurement of labor resources. The requisition module is further to allow a user to create a requisition that identifies a plurality of individuals that must take action during one of requisition approval process and candidate submission process.

A further preferred embodiment of the present invention is directed to an apparatus for managing time related work activities of at least one worker for at least one client. The apparatus comprises a computer system including a requisition module and a time track module. The requisition module is configured to track and manage procurement of labor resources. The requisition module includes one or more user interfaces for allowing a client or a service provider to enter information relating to procurement of labor resources. The time track module is configured to track and manage time spent by one of more laborers including a primary timesheet approver to approve a timesheet submitted by a user. The time track module includes one or more user interfaces that allow a primary timesheet approver to designate one or more secondary approvers to approve timesheets should the primary timesheet approver be unable to do so.

### BRIEF DESCRIPTION OF THE DRAWINGS OF A PREFERRED EMBODIMENT OF THE PRESENT INVENTION

FIG. 1 is a schematic diagram illustrating one of numerous possible configurations of a preferred embodiment of the present invention.

FIGS. 2 and 3 are block diagrams showing sample interactions among users of a preferred form of the present invention in a thin client embodiment.

FIG. 4 is a flow diagram of the interaction between various system users and the CSTS or ReqTrack component of a preferred form of the present invention.

FIG. 5 is a key legend for FIG. 4.

FIG. 6 illustrates a preferred requisition process.

FIG. 7 illustrates a preferred candidate submission process.

FIG. 8 is a schematic diagram showing various elements of a preferred embodiment of the present invention.

FIG. 9 is a schematic diagram illustrating a sample time sheet approval and bill presentment process formed in accordance with a preferred embodiment of the present invention.

FIG. 10 is a preferred user interface (i.e., screenshot) that allows a primary timesheet approver to enter personal identification information as well as secondary or alternate timesheet approvers.

FIG. 11 is a preferred user interface that allows a client initiator to create a job requisition.

FIG. 12 is a preferred user interface that allows a client initiator to create a direct source requisition.

FIG. 13 is a preferred user interface that allows a client initiator to create an extension requisition.

FIGS. 14 and 15 are preferred user interfaces that are employed in the candidate submission process.

FIG. 16 is a preferred user interface that confirms the contract data when a candidate is hired to fill a requisition.

FIGS. 17 to 32 illustrate preferred forms of user interfaces and specialized reports generated through the corresponding user interface.

### DETAILED DESCRIPTION OF THE PREFERRED EMBODIMENTS OF THE INVENTION

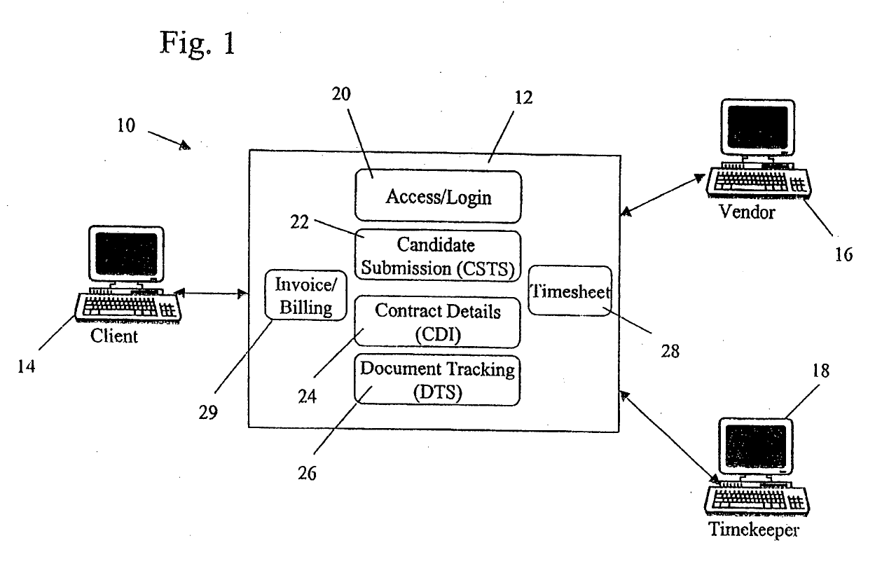

The preferred forms of the invention will now be described with reference to FIGS. 1-32. The appended claims are not limited to the preferred forms and no term and/or phrase used herein is to be given a meaning other than its ordinary meaning unless it is expressly stated that the term and/or phrase shall have a special meaning.

As shown in FIGS. 1 to 3, the most preferred form of system 10 of the present invention includes a management component 12 in two-way communication with at least one administrator 13, at least one client 14, at least one vendor/supplier 16 and at least one timekeeper 18 for managing numerous facets of the work relationship. The term “client” in this context refers to an entity contracting with one or more workers to receive performance, typically in the form of specified services, from the one or more contractors performing the work. The present invention allows the client 14 to review, approve and monitor various aspects of the work relationship as more fully explained below. A “client manager” or “initiator/manager” can be a client user of the systems and methods of the present invention. The term “vendor” or “supplier” in this context refers to an entity that supplies contract resources, such as a placement or temporary contracting agency. Such entities typically act as an intermediary between qualified individuals and companies and clients desiring their employ. The terms “timekeeper”, “contractor” and “consultant” can be used interchangeably in this context to refer to individuals who are employed by the client to provide performance of a contract, typically in the form of services. A “managing consultant” can be an individual associated with one or more contractors, either as part of the contractor entity or the vendor entity, who might use the systems and methods of the present invention. The term “administrator” in this context refers to an entity that is responsible for maintaining and administering the systems and methods of the present invention. The administrator may also be one of many vendors that simultaneously use the present invention. Alternatively, the administrator may be affiliated (e.g., parent, subsidiary, sister company) with one or more vendors that use the present invention.

The configuration and operation of system 10 for providing end-to-end integration of the contract resourcing process is explained in detail in U.S. patent application Ser. No. 10/962,762 filed on Jun. 7, 2004, the entire contents of which are incorporated herein by reference. It will be readily appreciated that one or more aspects of the present invention may be used with the system disclosed in U.S. patent application Ser. No. 10/962,762. Alternatively, one or more aspects of the present invention may be used with only certain portions of the system disclosed in U.S. patent application Ser. No. 10/962,762. Further, the present invention may be used with a system different from that disclosed in U.S. patent application Ser. No. 10/962,762. Accordingly, the reference to U.S. patent application Ser. No. 10/962,762 is not to be used to limit the scope of the subject claims. Moreover, if a difference between terminology used in the present application (i.e., without reference to the material incorporated by reference) and any material incorporated by reference (e.g., U.S. patent application Ser. No. 10/962,762) is deemed to exist, the terminology of the present application (i.e., without reference to the material incorporated by reference) is to govern the interpretation of terms in the claims of the subject patent application.

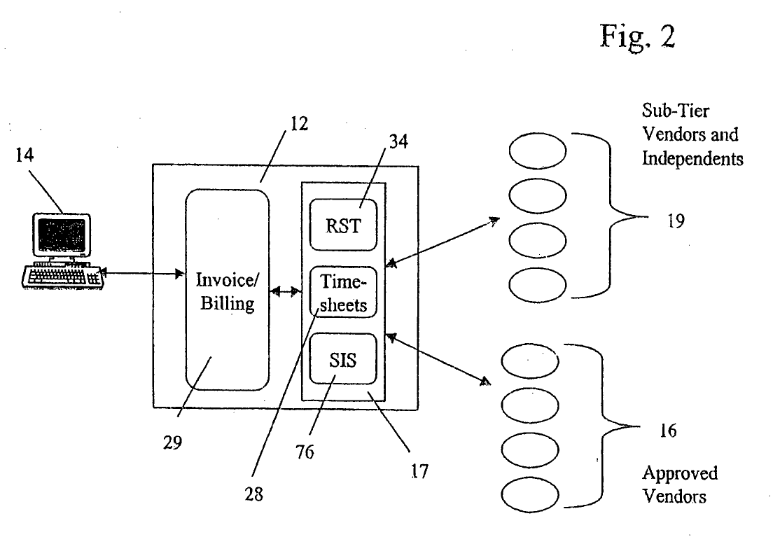

Referring to FIG. 1, management component 12 most preferably is provided in the form of a secure web site accessible via a public network such as the Internet, for example. As shown in FIG. 1, management component 12 includes sub-components such as access/login component 20, candidate submission and tracking system (CSTS) component 22 (also known as requisition module or ReqTrack), contract data/details input (CDD component 24, document tracking system (DTS) component 26 and timesheet component 28. A billing component 29 can also be part of management component 12, as shown in FIGS. 1 and 2, or can be a separate component interacting with management component 12.

Access/login component 20 provides a level of security to the present invention, by requiring any entity accessing the management component to be appropriately authorized and provided with at least one element of security (e.g., password, spoken input, fingerprint scan). Further, the access/login component 20 allows the system 10 to readily and automatically restrict a given user entity's access to one or more portions of system 10. Specifically, by assigning a user entity a unique login and associating an authorization level for that user with the user entity login, the system 10 can readily restrict any user entity's access to any portion of system 10. For example, user X is provided a login unique to user X. User X is assigned a particular authorization that is indexed or otherwise associated with user X's login. User X's authorization can permit or prohibit user X from creating, modifying, generating, accessing and/or reviewing information (e.g., reports stored or generated in system 10 or any electronically stored documents in system 10).

CSTS component 22 (also known as requisition module or ReqTrack) allows client 14 to present requisition information to the system so as to receive qualified candidates for a particular job, and also allows vendors 16 and even individual contractors 18 to submit one or more candidates (which may be themselves, in the case of a contractor submission) in response to the requisition notice from the client. In short, CSTS component 22 manages the candidate submission workflow from requisition to hire, tracks job status and information related to the requisitioning process, and reports on hiring process and other metrics.

CDI component 24 allows for the creation, editing, extension, reporting, storage and integration of contract details associated with a contracted-for job, which can trigger certain business rules affecting the timesheet and billing system aspect of a preferred form.

DTS component 26 provides for the management, reporting, storage and tracking of documents and communications affecting components 22, 24, 28 and 29, including invoicing and payment.

Timesheet component 28 provides interfaces and communications necessary to input, transmit and report timesheets for a particular contractor on a particular project, receive feedback and/or approval of the transmitted timesheet from the client, and process the timesheet for billing once approved. Timesheet component 28 may be the primary interface for the contractor.

Billing component 29 interacts with timesheet component 28 to automate processing of invoices and payment in connection with approved timesheets.

The preferred forms of management component 12, CSTS component 22, CDI component 24, DTS component 26 and timesheet component 28 are more fully described in U.S. patent application Ser. No. 10/962,762 filed on Jun. 7, 2004.

As described herein, certain exemplary embodiments of the invention can be implemented using a plurality of computers which, depending on circumstances, may communicate over one or more networks of computers such as, e.g., a local area network (LAN), a wide area network (WAN), a public network, such as the Internet, for example and/or another network. In various embodiments, as described herein, one or more servers, client computers, application computers and/or other computers can be used to implement one or more aspects of the invention. As an example, management component 12 can be a single computer having memory and programming sufficient to accommodate the requirements of sub-components 20, 22, 24, 26 and 28. Alternatively, individual dedicated computers can be provided with memory and programming to accommodate the requirements of a respective component or sub-component. In one embodiment, the invention can be deployed in an application service provider (ASP) format, with users accessing the invention using a public network, such as the Internet, for example.

Illustrative computers for use with the present invention can include, for example, a central processing unit, memory (ROM, RAM, etc.), digital data storage (e.g., hard drives, etc.), input/output ports (e.g., parallel and/or serial ports, etc.) and data entry devices (e.g., keyboards). User computers may contain, in some embodiments, browser software for interacting with the server such as, for example, using hypertext transfer protocol (HTTP) to make requests of the servers via the Internet or the like, in addition, various computers can include other protocols as needed to effectuate communications described therein, such as, for example, file transfer protocol (FTP) for transferring, uploading and/or downloading files and/or the like.

Additionally, in some exemplary embodiments, the system can use relational databases, such as, for example, employing a relational database management system (RDBMS) program to create, update and/or administer a relational database. The RDBMS can be adapted to take Structured Query Language (SQL) statements entered by a user or contained in an application program and create, update and/or provide access to database(s). Some illustrative RDBMS's include Oracle™ databases, and IBM DB2™ databases. In some illustrative embodiments, one or more user computers can be provided, such as, for example, as a LAN-based system. The user computers can include an appropriate operating system, such as, for example, Windows N™ or other systems known in the art. The system can also provide an object based graphical user interface (GUI) on one or more user computers.

In some illustrative embodiments, process steps can be carried out via computers by way of their central processing unit (CPU), which can communicate with a set of input/output (I/O) devices over a bus. The I/O devices can include, for example, a keyboard, mouse, video monitor, printer and/or other devices. The CPU can communicate with a computer readable medium (e.g., conventional volatile or non-volatile data storage devices) and/or memory over the bus. The interaction between a CPU, I/O devices, a bus and a memory will be appreciated by those of ordinary skill in the art. Memory can include, for example, data and can also store software. The software can include a number of modules for implementing the steps of processes, such as computer implemented steps of the processes described herein. Conventional programming techniques can be used to implement these modules.

In at least one embodiment of the present invention, the various methods described herein can be implemented in computer program products for use with a computer system. This implementation may, for example, include a series of computer instructions fixed on a computer readable medium (e.g., a diskette, CD-ROM, ROM or the like) or transmittable to a computer system via an interface device, such as a modem or the like. The medium may be substantially tangible (e.g., communication lines) and/or substantially intangible (e.g., wireless media, infrared, etc.). The computer instructions can be written in various programming languages and/or can be stored in one or more memory devices, such as semiconductor devices (i.e., chips or circuits), magnetic devices, optical devices and/or other memory devices. Transmission can occur using appropriate communications technology.

As shown in FIG. 2, one embodiment of the present invention allows a client 14 and its vendors 16 and sub-tier vendors 19 to interact with management component 12. As shown in the embodiment of FIG. 2, invoice/billing component 29 is incorporated to allow the client 14 to view and approve contractor invoices, and to further allow bills to be automatically generated. It will be appreciated, in this embodiment, that both approved vendors 16 and sub-tier vendors and/or independent contractors 19 are in two-way communication with a vendor access component 17 of management component 12. In this embodiment, vendor access component 17 can include timesheet component 28, a supplier inquiry system (SIS) 76 and a retail sales tax component (RST) 34. Vendor access component 17 can be part of management component 12, or can be logically or physically separate from management component 12. While FIG. 2 shows an embodiment of the invention with a billing option, it will be appreciated that the present invention can also operate in a thin client environment with no billing option. In such an embodiment, approved vendors can view vendor-specific information directly through a separate vendor access component 17.

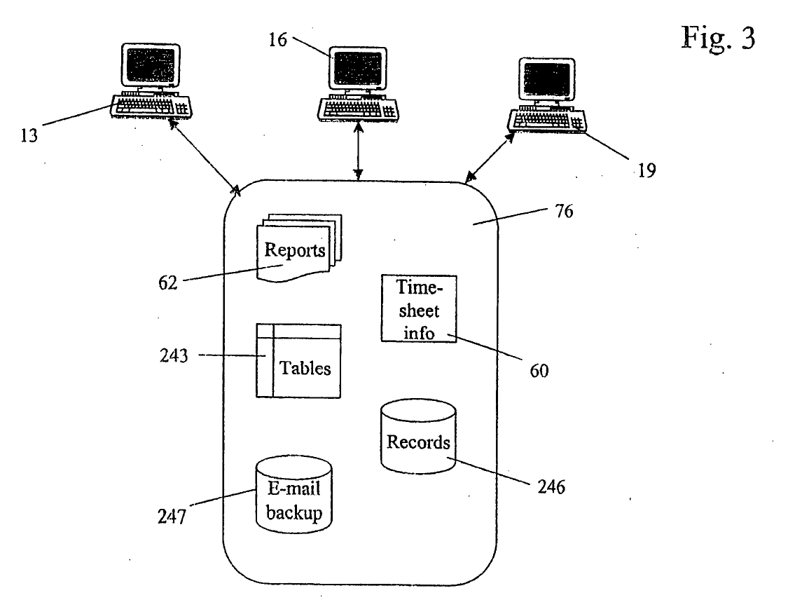

As shown in FIG. 3, SIS 76 allows administrative personnel 13 as well as suppliers, such as approved vendors 16 and sub-tier vendors and independents 19, to access timesheet information 60, reports 62, tables 243, records 246 and e-mails 247 formed in the operation of the present invention. As previously explained, the ability of any system user to access various portions of the system may be readily restricted.

RST component 34 is more fully described in U.S. patent application Ser. No. 10/962,762 filed on Jun. 7, 2004.

The communications component of the present invention, which can be part of DTS component 26 in one embodiment, can issue alerts to appropriate entities regarding an entities' specific business rules or general business rules. For example, an entity may be alerted to matters of concern, such as purchase order (PO) exhaustion, contract expiry, time sheet rejection, and/or missing time sheets.

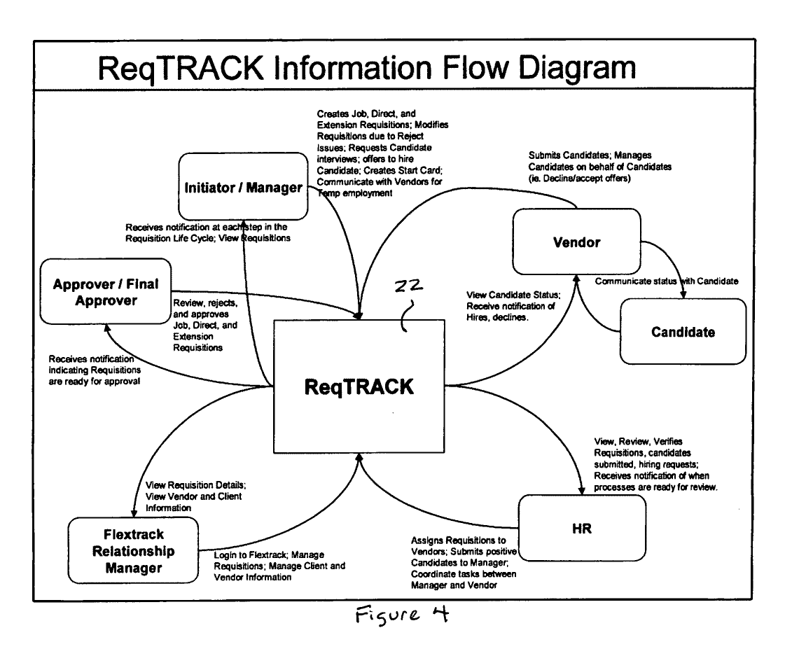

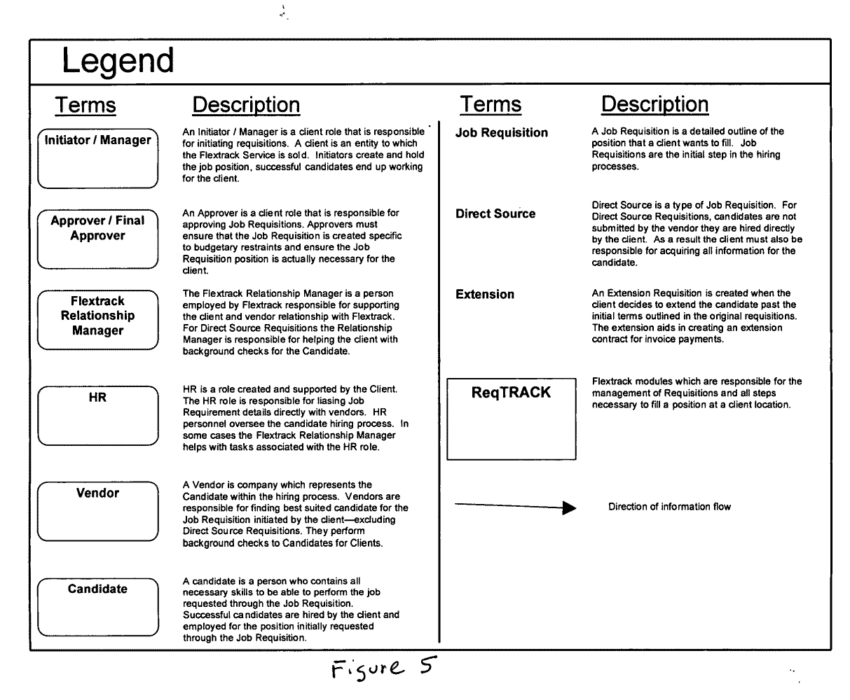

FIG. 4 illustrates a flow diagram of the preferred form of the process of requisitioning labor for performance of services for the client. More specifically, FIG. 4 illustrates the roles that various entities perform and their interaction with CSTS or ReqTrack component 2 in the process of requisitioning of labor for the client. FIG. 5 provides a legend for the terminology used in FIG. 4.

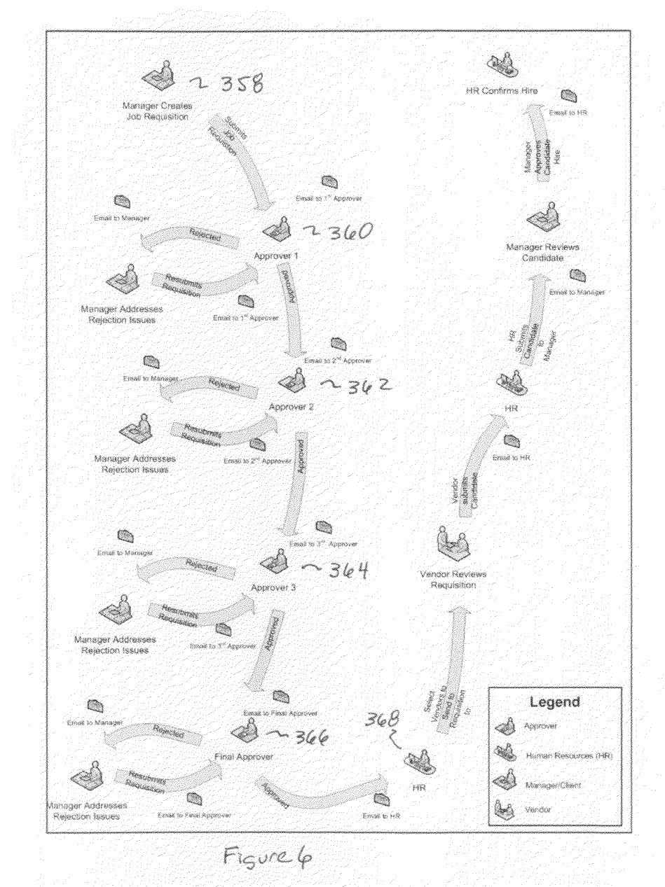

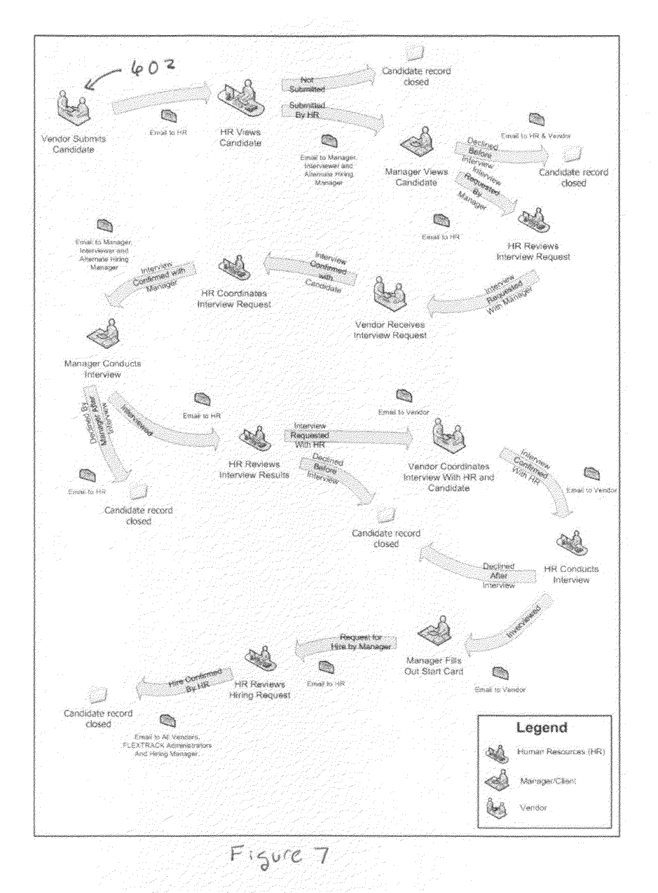

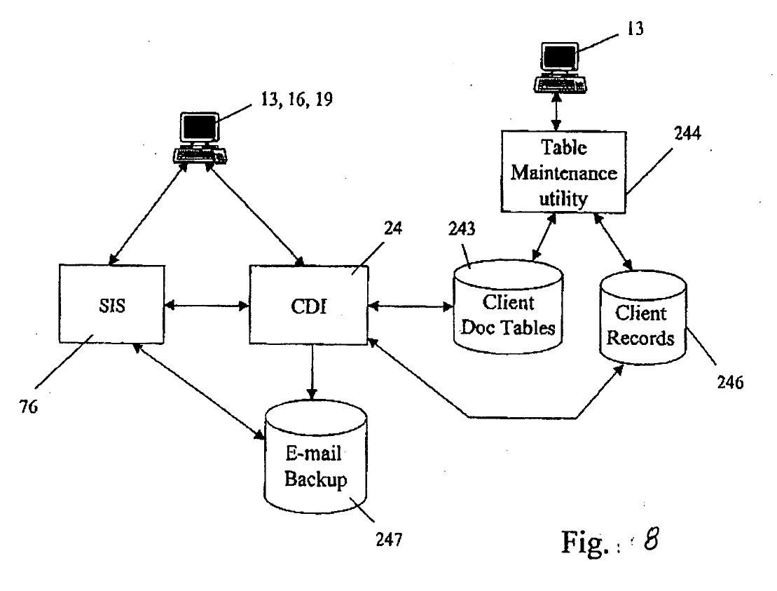

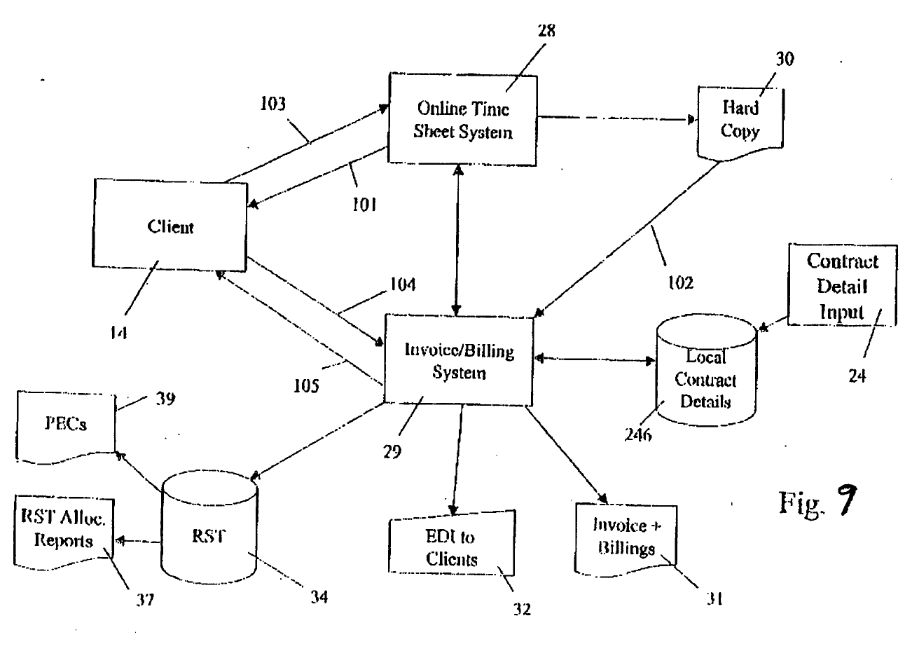

FIG. 6 illustrates a preferred for of the process of requisitioning labor for performance of services from the creation of the requisition by client to the hiring of an acceptable candidate. Once the candidate is hired they are known as a contractor, consultant or timekeeper. FIG. 7 illustrates a preferred process of requisitioning labor for performance of services from the client from the point a candidate is submitted by a vendor for a particular job requisition to the hiring of the candidate.

Once the candidate is admitted for work as a contractor, the contractor can be provided with access to the system 10. During course of performance of the work and as agreed by contract, the contractor can then input time into the system. This time is then presented to the client for approval in accordance with the details described hereinafter, and if the client is agreeable to the entered time, the client notifies the system of approval of the contractor's time. The system of the preferred form of the present invention then approves the invoice presented by the contractor/vendor and issues payment. The vendor then receives payment. Examples of user interfaces associated with these steps are described in U.S. patent application Ser. No. 10/962,762 filed on Jun. 7, 2004.

One aspect of the preferred form of the present invention is the ability to track, store, document and manage information relating to work relationships. The data input in the creation of the job requisition including but not limited to position/title, start date, end date, cost centre, acceptable billing rate or billing range, job number, skills set, experience, duration, sector, location, initiator of the requisition, requisition approvers, alternate hiring manager, interviewer and type of employment (e.g. contract, full-time), client, etc., can be tracked by CSTS component 22 and stored in tables or otherwise for use in various aspects of the preferred form of the present invention. Similarly, the data input during the candidate submission process including but not limited to billing rate, job number, skill set, experience, supplier, vendor, availability, etc. can be tracked by CSTS component 22 and stored in tables or otherwise for use in various aspects of the preferred form of the present invention. It should be noted that the preferred form of the present invention can be readily adapted to track and store other data. For example, the job posting for one client may include numerous other details that can be tracked and stored for subsequent use. Once the contract is approved and executed by the parties, contract data input (CDI) component 24 can track and store data including but not limited to hire rate, client, vendor, contractor, skill set, experience, location, sector, time frame, type of employment, duration, position/title, etc. for use in various aspects of the preferred form of the present invention. The status (e.g., active or inactive) of the employment relationship may also be tracked, stored and updated for use in various aspects of the preferred form of the present invention. All such data can be stored in tables as at 243 in FIG. 8 and retrieved as desired. However, it will be readily appreciated that the present invention is not limited to tables for storing data. Rather, any suitable storage method may be used.

As further shown in FIG. 8, administrative personnel 13 can manipulate the set up and contents of table database 243 via table maintenance utility 244. Also, administrative personnel 13, approved vendors 16 and sub-tier vendors 19 can access SIS and CDI, which can further communicate with each other. SIS permits access to items such as, for example, timesheet information 60, reports 62, tables 243, records 246 and e-mails 247 formed in the operation of the present invention.

As shown in FIG. 9, time sheet system 28 and billing system 29 interact to process timesheets as required (e.g., “blue ink” signature, electronic) by the client 14. Timesheet requirements can be indicated by the client at the time contract details are entered into system 10. In one embodiment, timesheet component 28 includes a contract term implementation component to automatically set timesheet recordation and transmission protocols pursuant to the contract terms and/or the client's preferred format indication. Once a contractor has finalized his or her timesheet, if the timesheet is permitted by the client to be submitted in electronic form, the time sheet system can submit it to client as at 101 for client review. If the timesheet must be submitted with “blue ink” signature, a hard copy 30 can be printed using timesheet component 28, signed and faxed or otherwise transmitted as at 102 to billing system for presenting to the client. In the case where the contractor and client are in close physical proximity to one another, a blue ink signature time sheet can be hand delivered to the client for approval. If the timesheet is not acceptable, the client can provide explanatory feedback as at 103 to the contractor via the timesheet system 28. Such feedback can also be directed by the client to the client's accounting department and/or the contractor's managing consultant. If the timesheet is acceptable, the client can indicate such as at 104 to billing system 29.

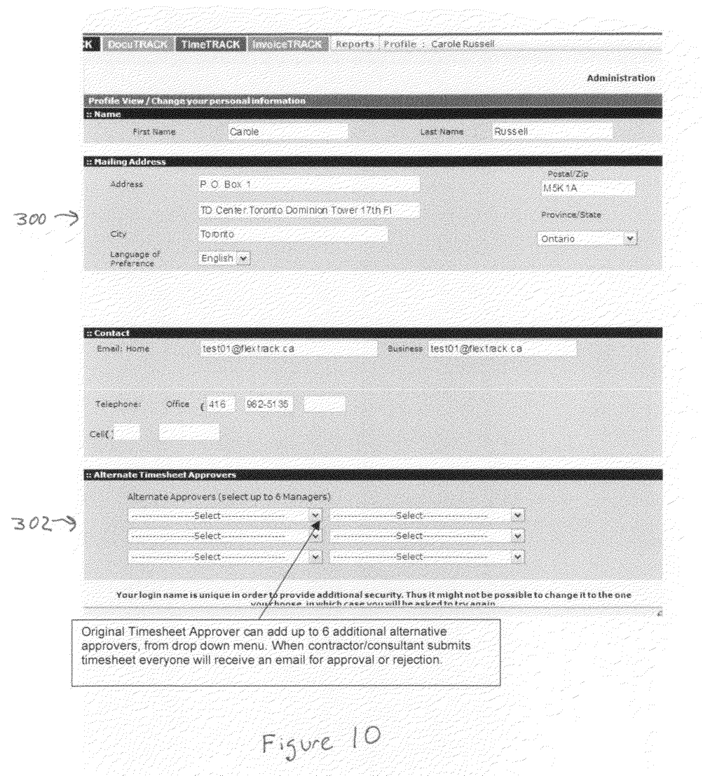

Preferably, the timesheet system 28 permits the client to designate secondary time sheet approvers to permit timesheets to acted upon despite the fact that the primary tine sheet approver is unavailable or otherwise incapable of acting on one or more submitted time sheets. This is accomplished by the primary time sheet approver accessing user interface screen 300 illustrated in FIG. 10. User interface screen 300 includes the personal identification information of the original or primary timesheet approver including, name, mailing address, e-mail addresses (e.g., home and business) and telephone numbers. In portion 302 of screen 300, the primary approver may designate up to six secondary or alternate time sheet approvers. Preferably, portion 302 includes six drop down menus each including a listing of possible secondary time sheet approvers permitting the primary approver to readily select the secondary approvers. Access to user interface 300 can be limited to the primary approver. Further, the primary time sheet approver may add or remove secondary approvers by accessing user interface 300. Preferably, the secondary approvers can approve all time sheets that the primary approver is authorized to approve. Once a time sheet is submitted, the primary approver and designated secondary approver receive a notification (e.g., e-mail or other suitable communication). If the timesheet is acted upon by, for example, the primary approver or the first designated secondary approver if the primary approver is unavailable, the remaining secondary approvers will be notified that the time sheet has been acted upon.

The primary approvers preferably can approve time sheets by logging into the system or through a secure e-mail. When logging into the system, the primary approver can access at once all time sheets that need to be approved. In the secure e-mail method, the primary approver is sent an e-mail with a link and a one time, three-digit security code. The primary approver clicks on the link and enters the one time, three-digit security code to access a particular time sheet for approval. Timesheet system 28 can restrict the secondary approvers to approve time sheets only be the secure e-mail method.

As further shown in FIG. 9, the CDI component 24 of the preferred form of the present invention can store contract details in database 246 for use by billing system component 29. Billing component 29 can retrieve items such as the invoice history for the client, or purchase order details, and forward such information to the client 14 as at 105 at the appropriate time. It will be appreciated that billing system component 29 can also present hard copies 31 of invoices and billings, and can transmit information 32 using electronic data interchange (EDI) to clients. RST component 34 facilitates accounting and reporting of retail sales tax, which may or may not be attributed depending upon the jurisdictions involved in a particular client's employment of a particular contractor. In one embodiment, if the client is not exempt from sales tax, the tax would be added to the invoice at the time of presentment to the client for payment. Such information can be presented in an RST allocation report as at 37, for example. If the client is not subject to retail sales tax, the present invention can facilitate completion of a purchase exemption certificate (PEC) 39, as required.

It will be appreciated that management component 12 can include software to facilitate certain business processes as part of a comprehensive contract management service (e.g., the Procom SoftLanding™ program, commercially available from Professional Computer Consultants, Ltd. of Toronto, Canada) in connection with the present invention. Such business processes can include, for example, corporate governance, document management, contractor performance reviews, project budget control and reporting, rate analysis, “psuedo-employment”, retail sales tax information and cost projection. It will also be appreciated that the present invention can be used in stand-alone mode, as well as alongside a vendor or client's own timesheet and/or billing software.

Referring to FIG. 11, an initiator/manager through CSTS or ReqTrack component 22 can access user interface 304 to create a job requisition. The user interface allows the manager to define the following information relevant to the requisition: position/title at 306, start date at 308, end date at 310, location at 312, billing rate or billing range at 314, number of contractors needed at 316, maximum number of resumes that may be submitted for the requisition at 318, cost center (assigns the department or unit within the client needing the contractor) at 320, requisition name at 322, job description at 324, mandatory skills at 326, preferable skills at 328, additional comments or instructions at 330, first approver at 332, second approver at 334, third approver at 336, final approver at 338, alternate hiring manager at 340, interviewer at 342, internal notes at 344 and cc's at 346 (any contact identified in field 346 will be provided a copy of any requisition generated e-mail). It should be noted that component 22 can be configured such that some or all of the above information can only be entered by the manager/initiator. Further, component 22 can be configured such that some or all of the above information entered on screen 304 can only be changed if the requisition is rejected. Further, component 22 can be configured such that the information for screen 304 can be entered from drop down menus set up by the client to facilitate data entry.

Referring to FIG. 6, the preferred job requisition process will now be described. The manage/initiator 358 creates the requisition using screen 304. The requisition is preferably saved by clicking on “Save” on screen 304. The job requisition is forwarded to the approvers predefined by the manager on screen 304 at 332, 334, 336 and 338. The first approver 360 receives the requisition via e-mail when the manager clicks on “Send to next approver” on screen 304. In the event approver 360 rejects the requisition, the manager 358 is notified. The manager can revise the requisition and resubmit the same to approver 360. If approver 360 approves the rejection, the requisition is forwarded to second approver 362 via e-mail when approver 360 clicks on “Send to next approver” on screen 304. The second approver 362 can either reject or approve the requisition. In the event that the requisition is rejected by second approver 362 the manager 358 is again notified preferably by e-mail. The requisition is forwarded to third approver 364 and the final approver 366 in a similar manner as illustrated in FIG. 6. Once the requisition is approved by the final approver 366, an e-mail is sent to HR 368, i.e., a designated individual or individuals in the client's Human Resources department. HR 368 decides selects the vendor or vendors to send the job requisition and system 10 transmits the requisition to the selected vendor or vendors.

The above requisition approval process provides the client with more control over the requisition before it is submitted to HR or vendors to facilitate the hiring of contractors. By allowing only the manager to edit the requisition, requisition errors are eliminated or greatly reduced. This approval process further allows the client to readily modify the same by identifying up to four different approvers with a required final approver. An alternate hiring manager may be assigned in the event that the initiator/manager is unavailable. The manager responsible for interviewing the contractor can be defined at this early stage further facilitating the hiring of a suitable contractor. The internal notes section improves communication between approvers during requisition and eliminates the need for external tools. The internal notes preferably are not viewable by any person outside of the client.

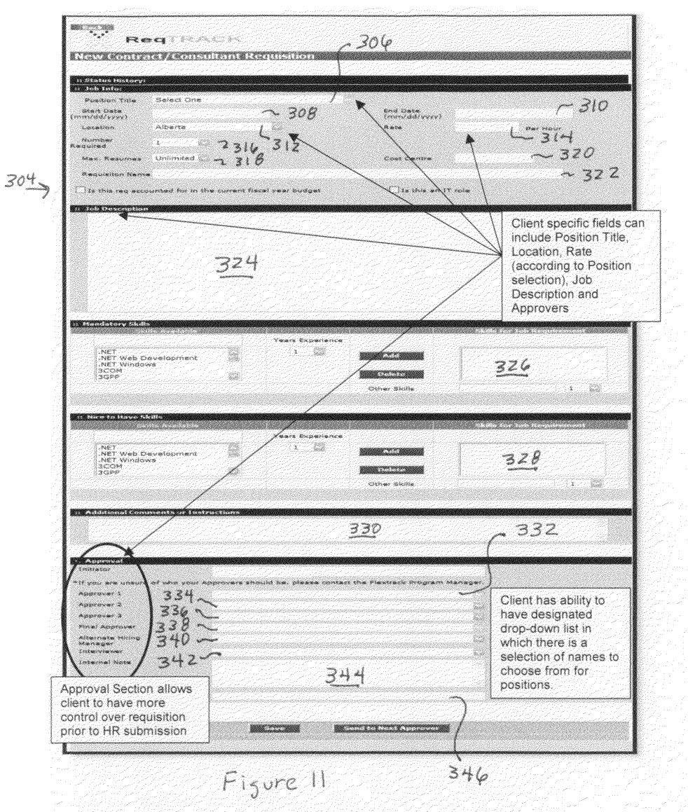

Referring to FIG. 12, an initiator/manager through CSTS or ReqTrack component 22 can access user interface 370 to create a direct source requisition. The manager uses screen 370 when the he or she knows the individual to be hired. In this requisition process, no vendor is necessary because the client already knows the identity of the individual that is to be hired. The name of the individual desired to be hired is entered at 372 and 374. The designated job information is entered in portion 376 of screen 370. Additional comments or instructions can be entered at 378 of screen 370. The same approval information can be entered at 380 of screen 370 so that the direct source requisition goes through the same approval process as job requisitions. The only difference being that the requisition is not transmitted to a vendor after being approved by the final approver.

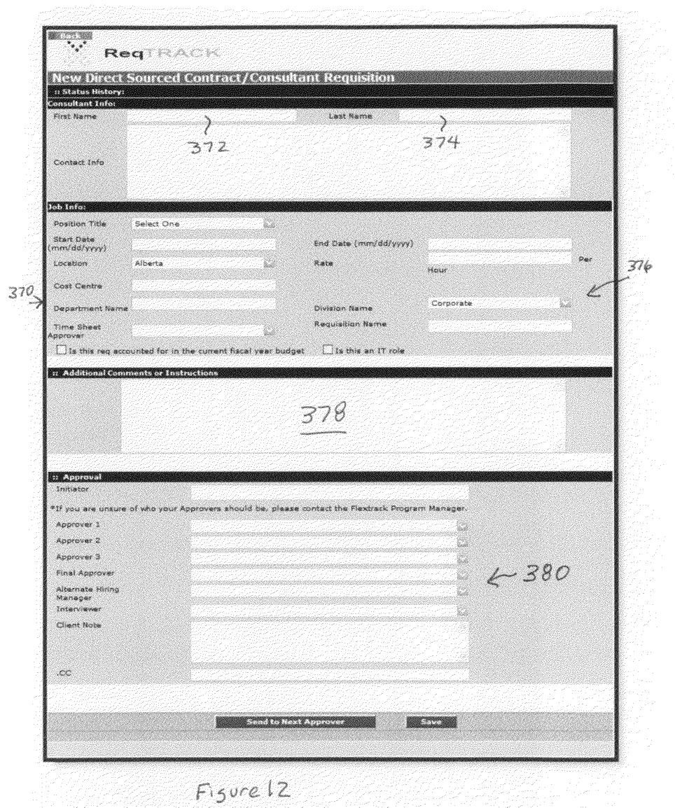

Referring to FIG. 13, an initiator/manager through CSTS or ReqTrack component 22 can access user interface 382 to create an extension requisition. The extension requisition created using screen 382 allows the client to facilitate the contract extension process for a contractor that is presently employed by the client. In other words, the extension requisition is used when the client wants to extend the employment period of an particular contractor beyond the previously defined employment period. The initiator/manager can enter the first and last name or portion thereof of the contractor for which an extension is desired at 384 and 386. The corresponding contractor or contractors will be listed at 388. By clicking on the desired contractor at 388, the first and last name of the contractor will be displayed at 390 and 392. Job information may be entered at portion 394. Additional comments or instructions can be entered at 396. The same approver information as the job requisition can be entered at 398 so that the extension requisition is approved in the same manner as the job requisition.

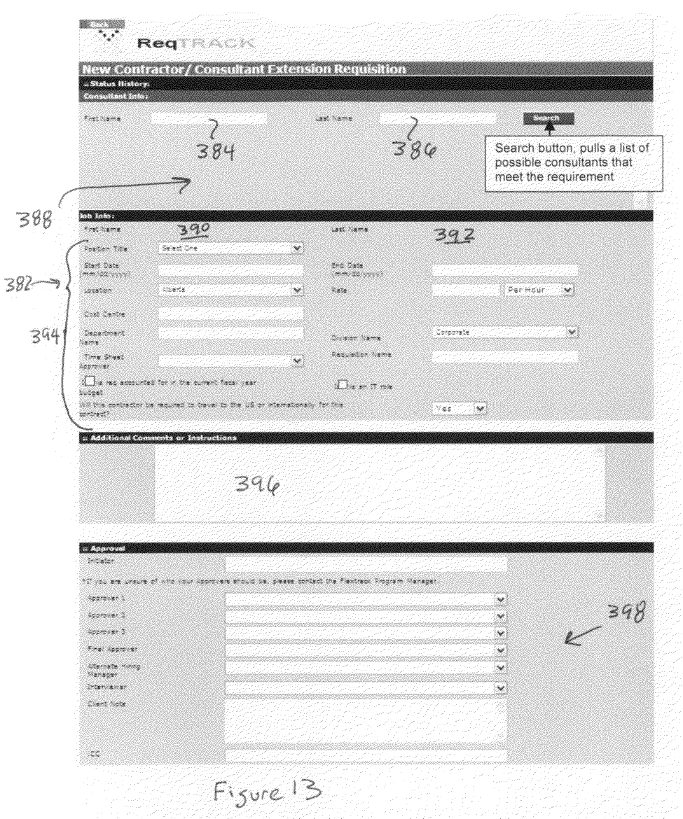

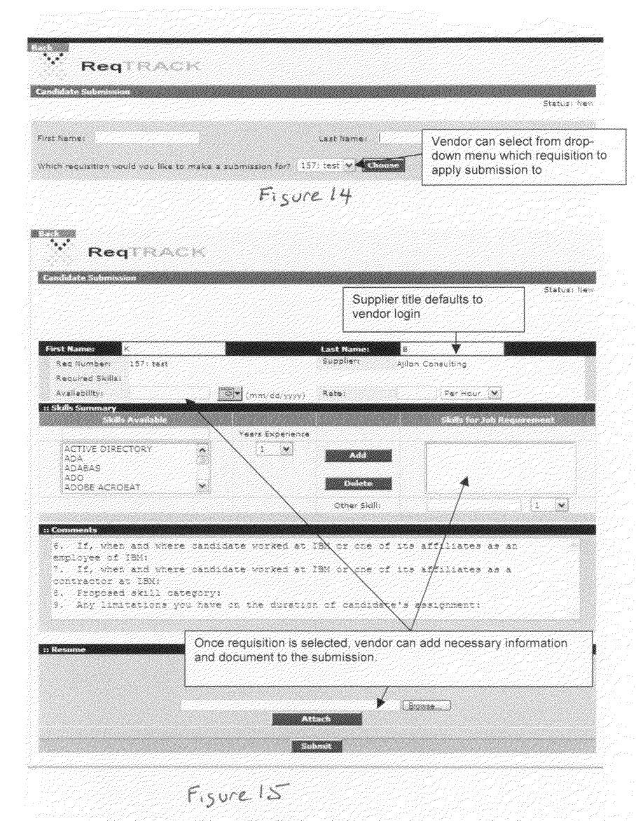

User interfaces 400 and 500 depicted in FIGS. 14 and 15 allows a vendor or other authorized user to submit a candidate for a specific requisition. Interface 400 allows an authorized system user to submit the name of a candidate and identify the particular requisition for which the candidate is to be considered. Once the information for interface 400 is entered, screen 500 is displayed. Screen 500 can be configured to automatically display at least some of the information required to be entered on screen 500 from the job requisition. Using portion 502 of screen 500 a candidates resume and any other documents may be submitted to the client for consideration. Detailed information about a particular candidate including name, vendor/supplier representing the candidate, pay rate, skill set of the candidate and years of experience may also be entered using screen 500. The information entered through screen 500 allows the appropriate user to review the candidate's qualifications and determine whether to hire the candidate. Information entered by an individual using interface 500 is tracked and stored by CSTS component 22 for subsequent use.

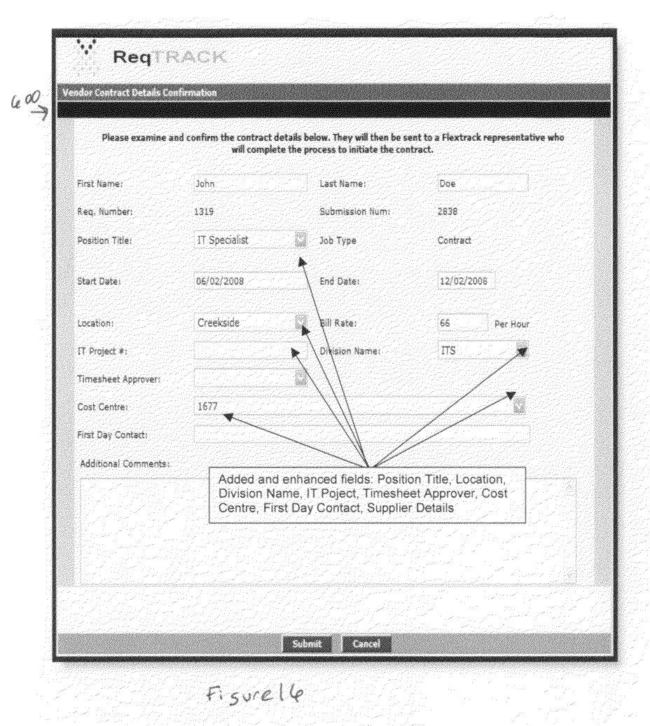

Once a candidate is selected for employment, a screen 600 is displayed seeking confirmation of the contract details (e.g., FIG. 16). This screen requires entry of all information regarding the contract that needs to be tracked and stored by CDI component 24 for subsequent use. In this manner, the system of the present invention is able to readily track and store any information relating to labor procurement desired. The information tracked by CSTS component 22 and CDI component 24 can be stored in one or more tables and subsequently accessed to create a market rate report.

Preferably, component 22 is configured to automatically display information required to be entered on screen 600 (also referred to as the start card) from the job requisition. Certain information required by screen 600 can be entered/edited by predefined drop down menus including position/title, location, division name and cost center. The first day contact field allows client to identify details for the candidate who is to begin work. FIG. 7 illustrates the preferred candidate submission process. Vendor 602 submits the candidate using screen 600.

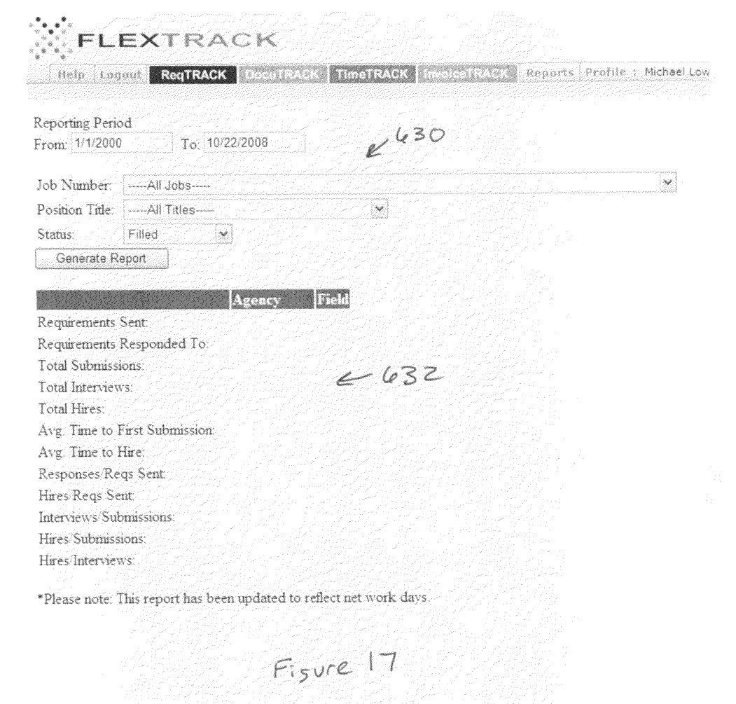

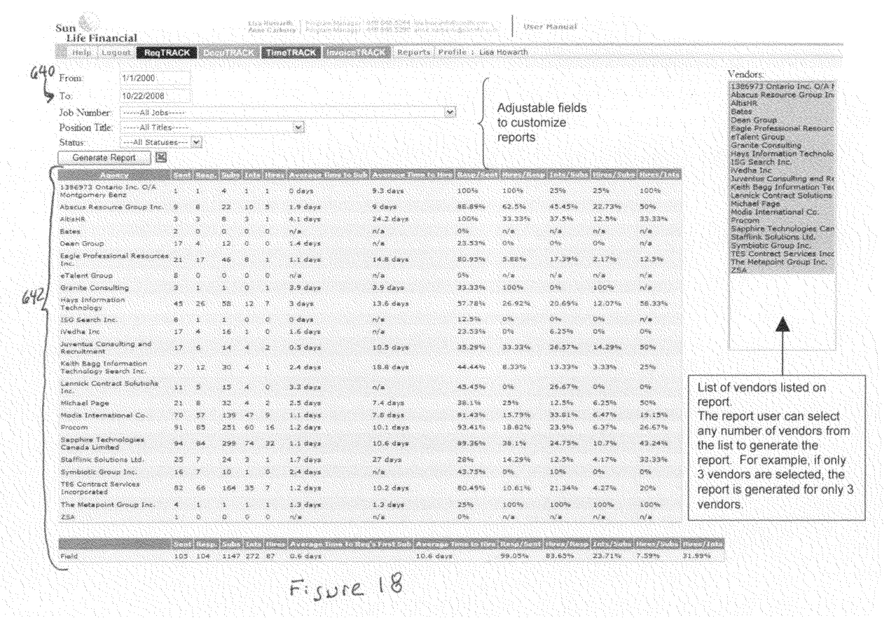

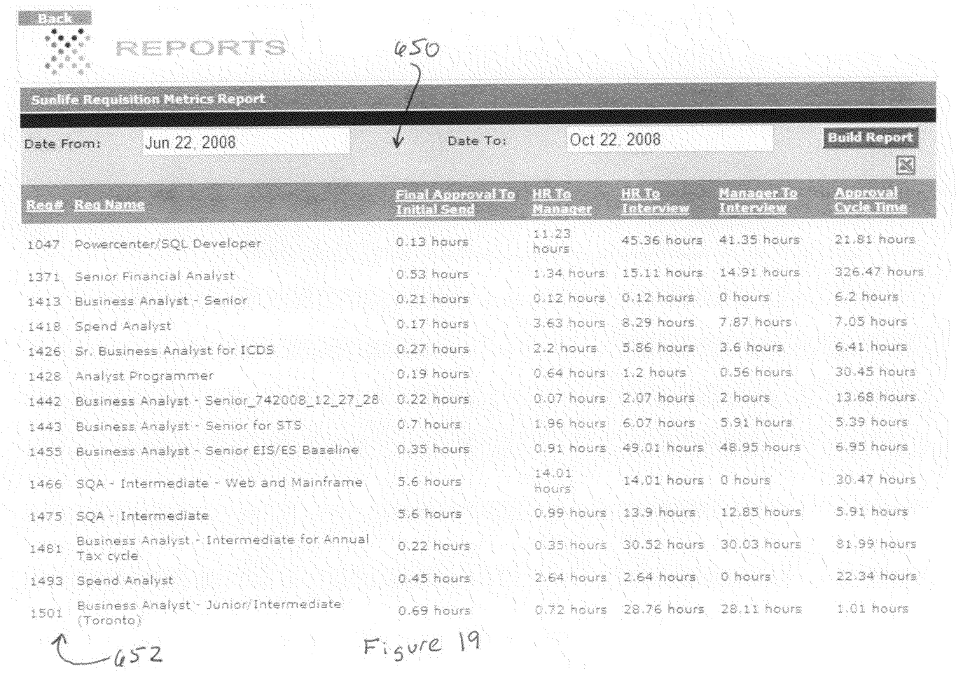

The time for each step in the job requisition and candidate submission process illustrated in FIGS. 6 and 7 can be tracked and stored by component 22 for subsequent use including generating reports that allows an authorized system user to evaluate various aspects of the job requisition and candidate submission process. FIGS. 17 through 19 illustrate user interfaces and reports generated therefrom that provide an authorized user to view metrics on the job requisition and candidate submission process so that the user can evaluate performance of certain entities. Using interface 630 illustrated in FIG. 17, a vendor can generate a report that allows the vendor to evaluate their performance for a specific client. The information provided by the report is identified at 632. Using interface 640 illustrated in FIG. 18, a client or the administrator can generate a report that allows these user to evaluate the performance of a number of vendors for a client. The information provided by the report is identified at 642. Using interface 650 illustrated in FIG. 19, a client can evaluate the performance of the client's internal staff in the requisition process illustrated in FIG. 6. The information provided by the report is identified at 652.

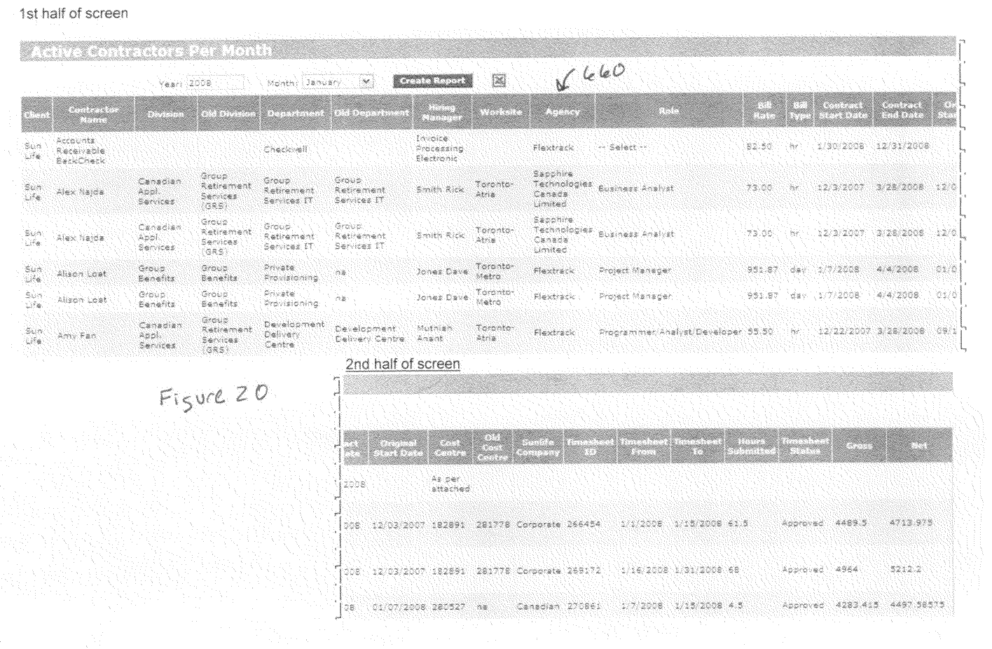

FIGS. 20 to 32 illustrate examples of further user interfaces and reports generated thereby. Using interface 660 illustrated in FIG. 20, an authorized user can generate a report identifying all active contracts for a specific month. Preferably, each statement of work (SOW) is considered a contract. For example, if a contractor has a contract from September 2007 to Jan. 1, 2008 and has an extension from Jan. 2, 2008 to Mar. 31, 2008 and a report for December 2007 is run the user will see the active contract ending on Jan. 1, 2008. However, if the report is run for January 2008 the user will see both the original contract and the extension contract. This allows for accurate collection of rate changes, department changes and SOW compliance with contracts which can be distorted when melding contracts.

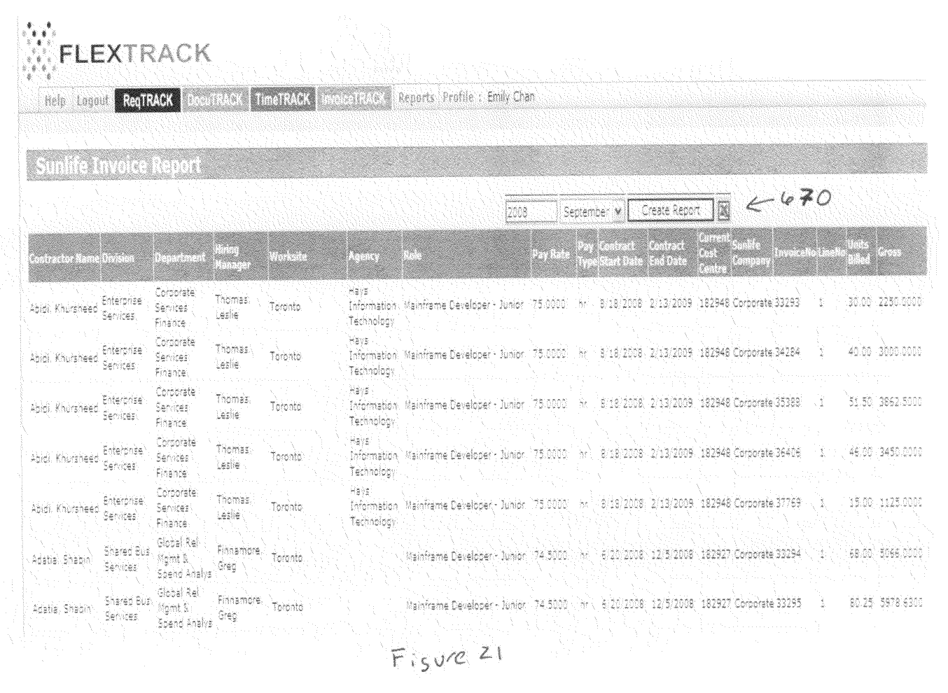

Using interface 670 illustrated in FIG. 21, an authorized user can generate a report listing all invoices for a specific month.

Using interface 680 illustrated in FIG. 22, an authorized user can create a document management report that identifies in portion 682 contracts the user has access to. The documents can be viewed by clicking on “Yes” or a number appearing in portion 682. This report can display more than one client to a particular authorized user.

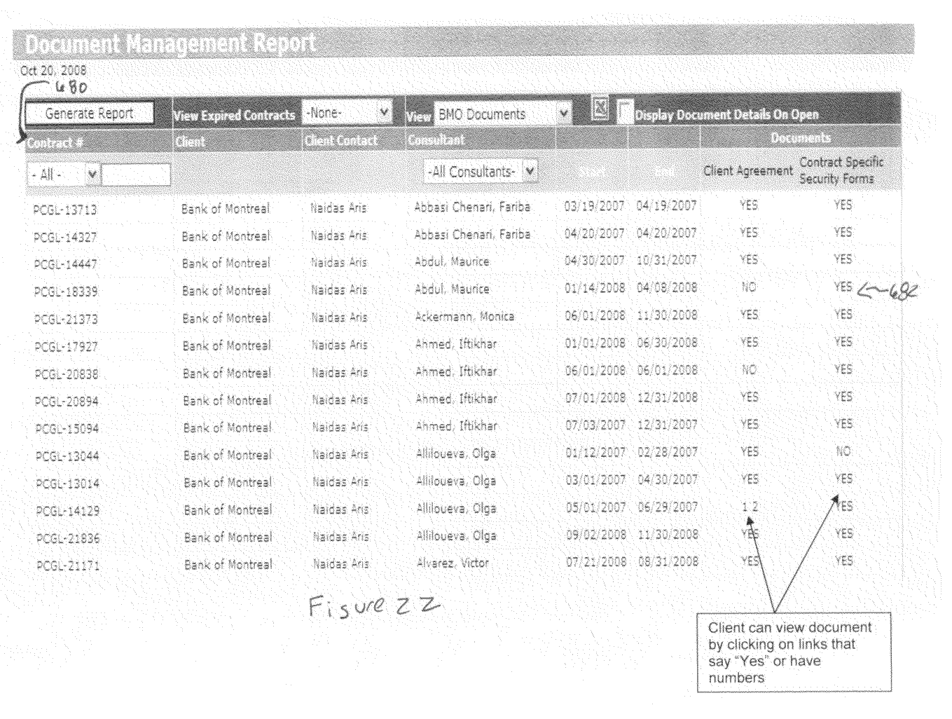

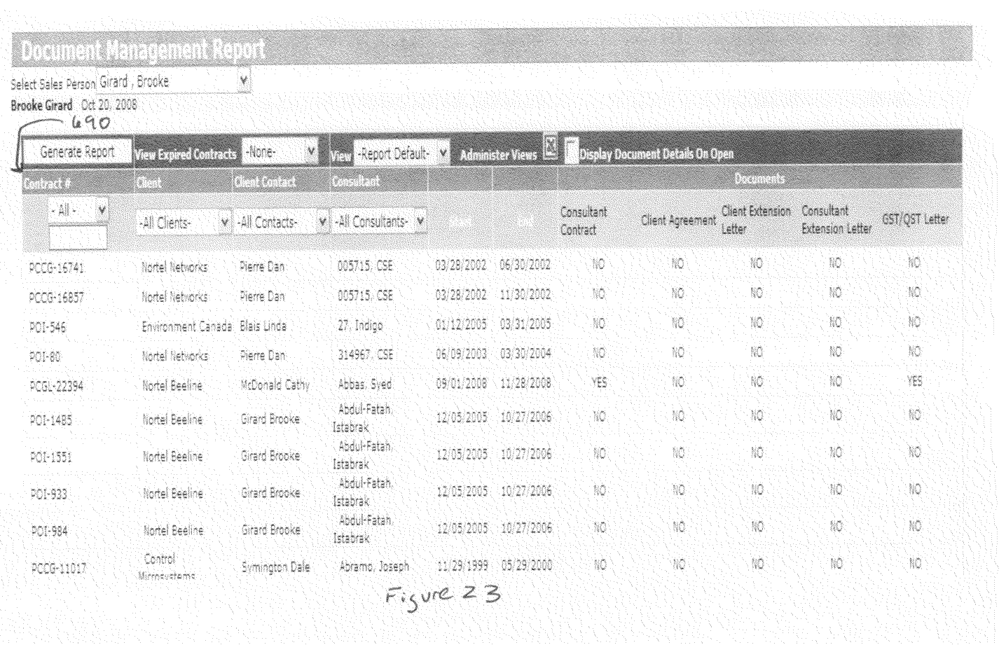

Using interface 690 illustrated in FIG. 23, an authorized user can create a document management report similar to that depicted in FIG. 22. The documents displayed are contract and consultant specific. This report is available to client contacts for specific contracts.

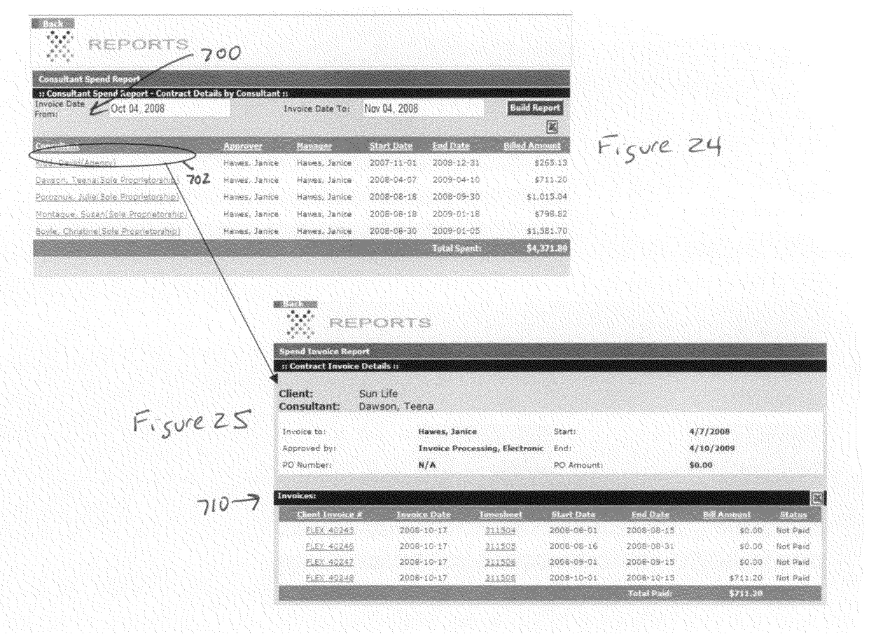

Using interface 700 illustrated in FIG. 24, an authorized user can create a consultant spend report to gather spending information by consultant. By clicking on the consultant link at e.g., 702 in FIG. 24, user interface 710 illustrated in FIG. 25 is displayed providing detailed spending information for the particular contract.

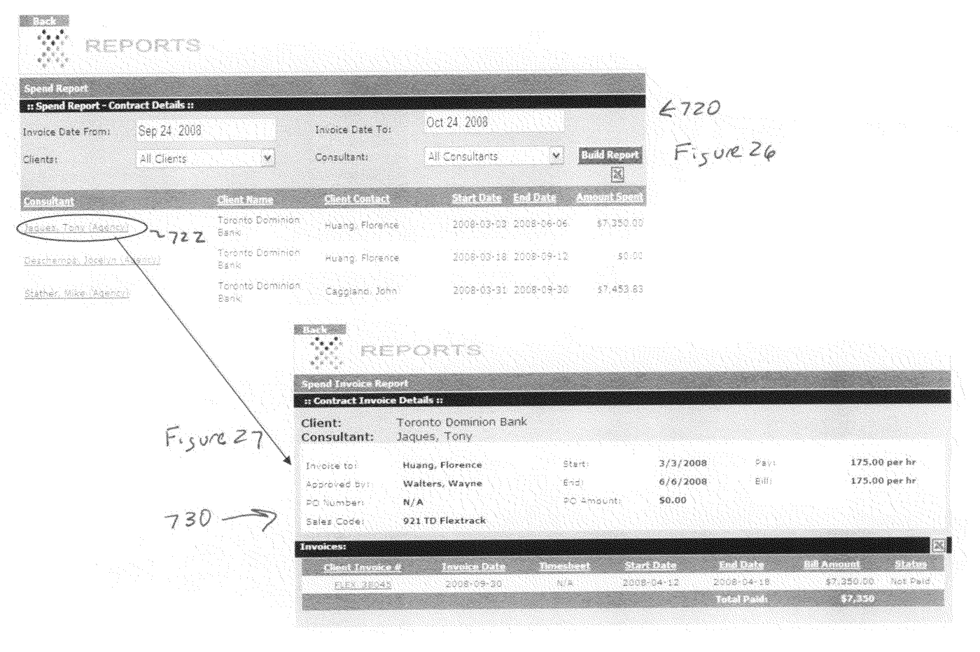

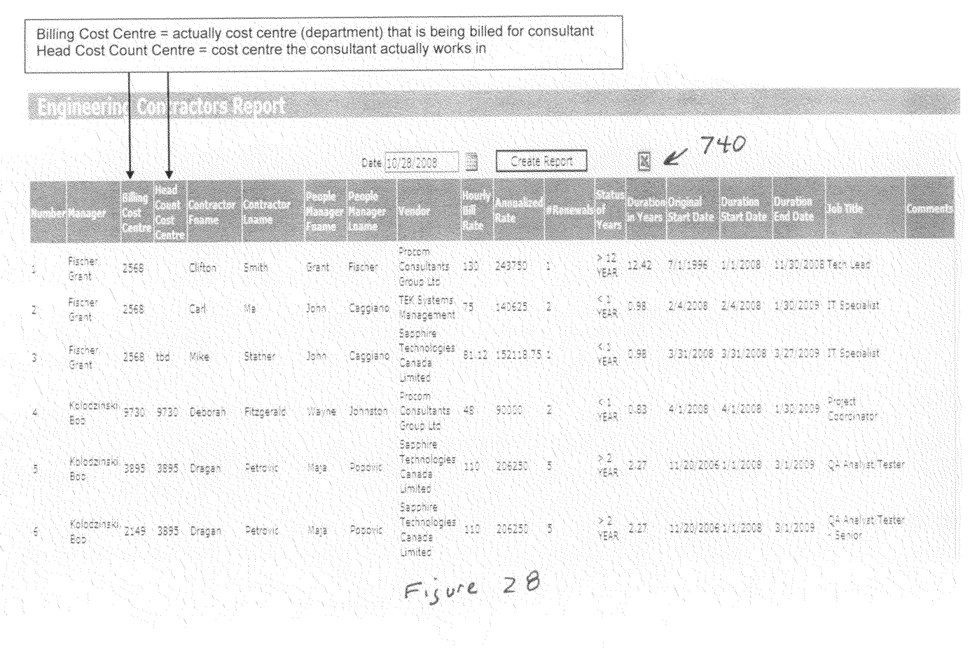

Using interface 720 illustrated in FIG. 26, an authorized user can create a vendor specific spend report. By clicking on the consultant link at e.g., 722 in FIG. 26, user interface 730 illustrated in FIG. 27 is displayed providing detailed spending information for a particular consultant.

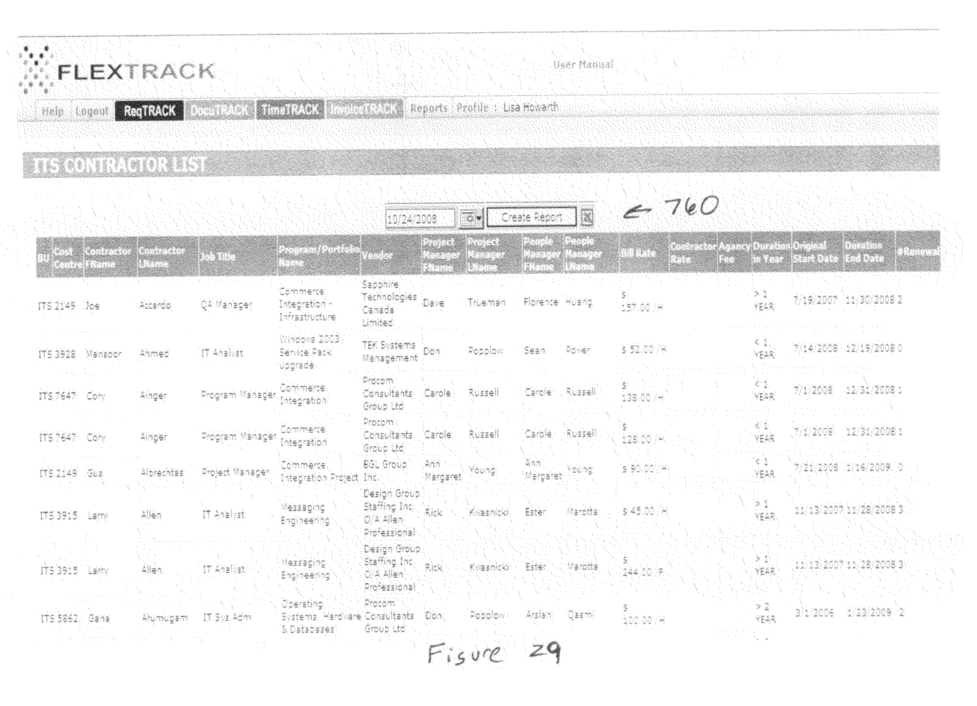

Using interface 740 illustrated in FIG. 28, an authorized user can create an engineering contracts report 750. Preferably, client managers have access to this report. The report is client specific. The report lists all contractors and metrics related to payment and length of term in the engineering division of the client. The billing cost center identifies the cost center that is actually billed for payments corresponding to services performed by a contractor. Head count cost center identifies the cost center for which the consultant actually works.

Using interface 760 illustrated in FIG. 29, an authorized user can create a report similar to that illustrated in FIG. 28 but is specific to the ITS division of the client.

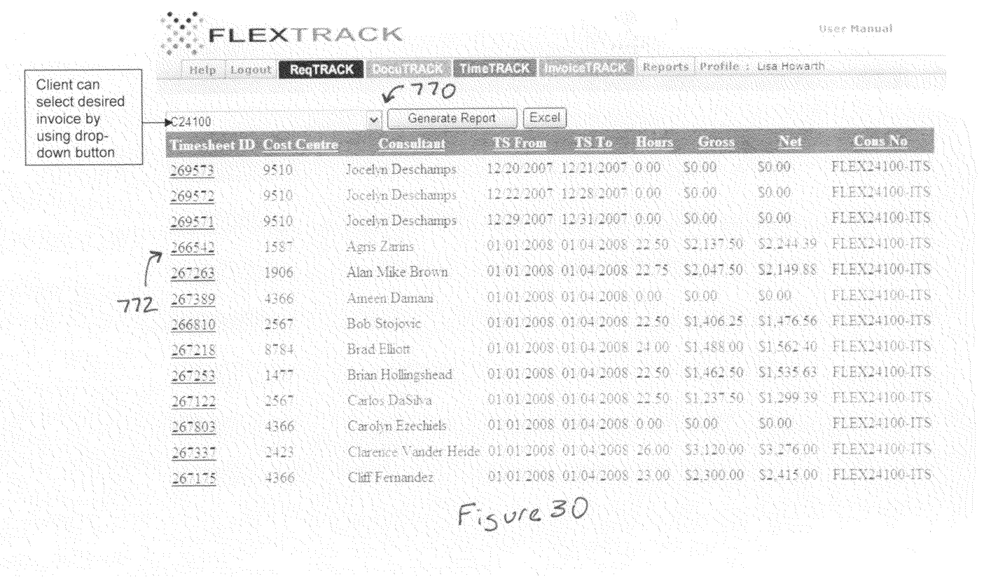

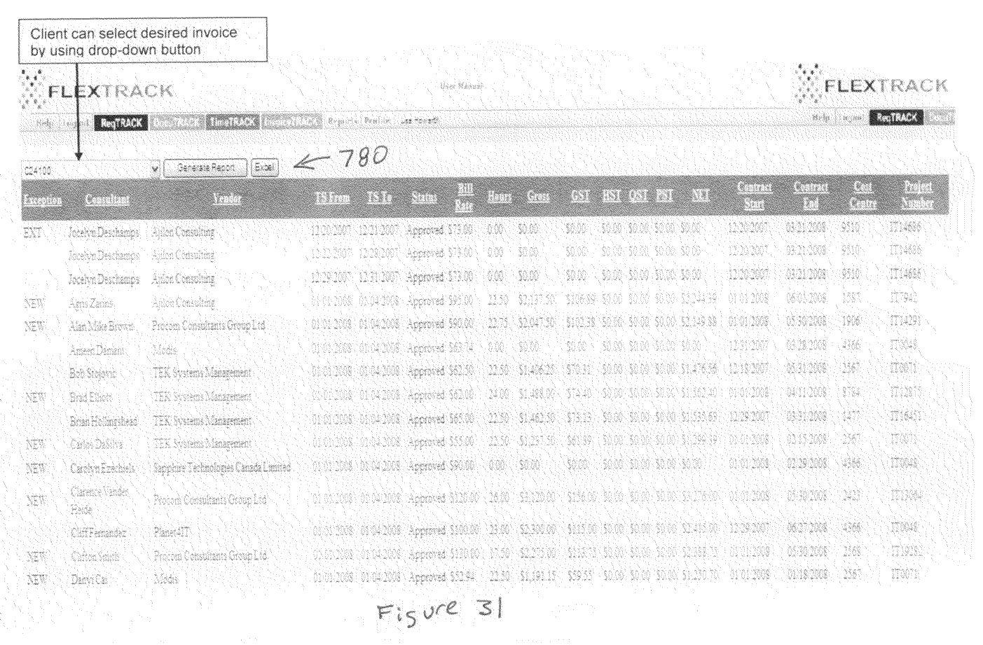

Using interface 770 illustrated in FIG. 30, an authorized user can create a consolidated invoice report to get a breakdown of all time sheets for any consolidated invoice. A consolidated invoice is made up of a group of invoices that are combined and sent as one invoice with a lump sum for client billing. By clicking on a specific timesheet ID (e.g., 772), the use can view the particular timesheet.

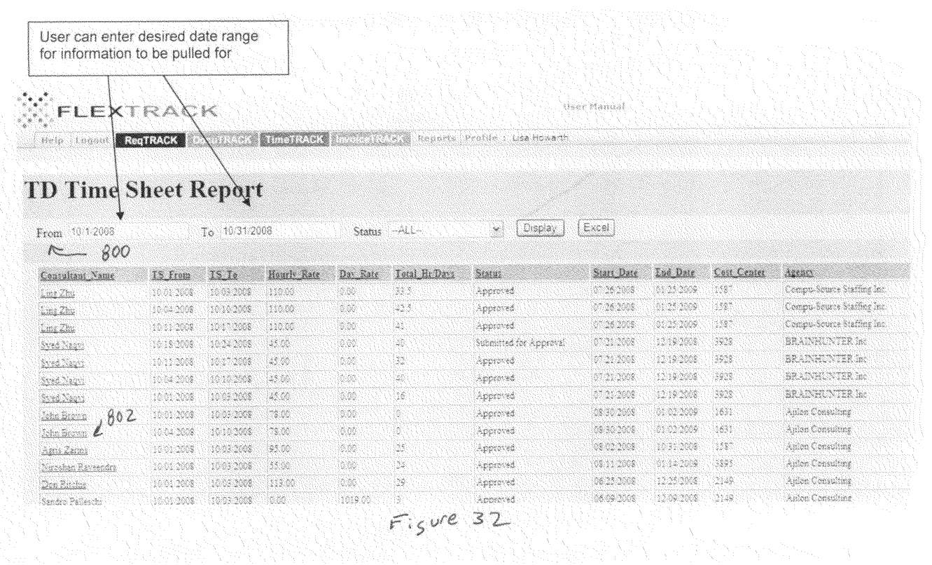

Using interface 780 illustrated in FIG. 31, an authorized user can create an exception report that is client specific. This report is a support to the original invoice and provides a breakdown on each time sheet that is invoiced on a given consolidated invoice. The report identifies exception for accounts payable. The exception can include timesheets where more than 48 hours were submitted in a given week, timesheets where a change of rate was made, timesheets that had a change in start date or end date, timesheets that had a change in cost center, the first timesheet created for a new contract and/or the first timesheet created by any new extension contract for an existing contractor.

Using interface 800 illustrated in FIG. 32, an authorized user can creates a time sheet spend report. This report provides a list of all timesheets within a specific date range defined by the user. The report also identifies the status for each timesheet (i.e., approved, rejected, submitted for approval, in progress). Each time sheet can e viewed by clicking on the consultant name (e.g. at 802) to ascertain the breakdown of hours, and when and by whom the timesheet was approved. Each timesheet is also available for printing.

While this invention has been described as having a preferred design, it is understood that the preferred design can be further modified or adapted following in general the principles of the invention and including but not limited to such departures from the present invention as come within the known or customary practice in the art to which the invention pertains. The claims are not limited to the preferred embodiment and have been written to preclude such a narrow construction using the principles of claim differentiation.

We claim:

1. An apparatus for managing time related work activities of at least one worker for at least one client, said apparatus comprising:
(a) a computer system, said computer system having a requisition module being configured to track and manage procurement of labor resources for at least one client; and
(b) said requisition module being further configured to allow a client user to create at least two of the following types of requisitions: (i) job requisition to be submitted to one or more vendors so that the client can procure the services of at least one worker for a position defined in the job requisition, (ii) a direct source requisition to allow the client to procure the services of at least one worker without any action by a vendor, and (iii) an extension requisition to allow the client to extend the employment of a worker presently providing services to the client.

2. An apparatus, as set forth in claim 1, wherein:
(a) said requisition module includes a plurality of user interfaces accessible over a network to create a job requisition, a direct source requisition and an extension requisition.

3. An apparatus, as set forth in claim 2, wherein:
(a) said requisition module is configured so that only a client initiator can create a job requisition, a direct source requisition and an extension requisition.

4. An apparatus, as set forth in claim 3, wherein:
(a) said requisition module is configured so that only a client initiator can edit a job requisition, a direct source requisition and an extension requisition.

5. An apparatus, as set forth in claim 2, wherein:
(a) at least one of said user interfaces allows a user to tailor at least one of the job requisition, direct source requisition and extension requisition to identify a cost center specific to the tailored requisition so that the cost center can be tracked and stored by said requisition module.

6. An apparatus, as set forth in claim 2, wherein:
(a) at least one of said user interfaces allows a user to tailor at least one of the job requisition, direct source requisition and extension requisition to identify a maximum number of resumes that may be submitted for the tailored requisition.

7. An apparatus, as set forth in claim 2, wherein:
(a) at least one of said user interfaces allows a user to tailor at least one of the job requisition, direct source requisition and extension requisition to identify an acceptable billing rate or billing range for the tailored requisition.

8. An apparatus, as set forth in claim 2, wherein:
(a) at least one of said user interfaces allows a user to tailor at least one of the job requisition, direct source requisition and extension requisition to identify key individuals in the requisition approval and candidate hiring processes.

9. An apparatus, as set forth in claim 2, wherein:
(a) said one or more user interfaces permit a client initiator to identify a plurality of client approvers for each of job requisition, direct source requisition and extension requisition.

10. An apparatus for managing time related work activities of at least one worker for at least one client, said apparatus comprising:
(a) a computer system, said computer system having a requisition module being configured to manage procurement of labor resources; and,
(b) said requisition module further being configured to allow a user to create a requisition that identifies a plurality of individuals that must take action during one of requisition approval process and candidate submission process.

11. An apparatus, as set forth in claim 10, wherein:
(a) said requisition module is further configured to allow a user to create a requisition that identifies a plurality of individuals that must take action during both requisition approval process and candidate submission process.

12. An apparatus, as set forth in claim 10, wherein:
(a) said requisition module is further configured to allow a user to create a requisition that identifies a plurality of individuals that must approve the requisition before the position identified by the requisition can be filled.

13. An apparatus, as set forth in claim 12, wherein:
(a) said requisition module is further configured to provide a user interface having a plurality of drop down menus to allow the user to identify the plurality of individuals that must approve the requisition.

14. An apparatus, as set forth in claim 10, wherein:
(a) the requisition is one of a job requisition to be submitted to one or more vendors so that the client can procure the services of at least one worker for a position defined in the job requisition, a direct source requisition to allow the client to procure the services of at least one worker without any action by a vendor, and an extension requisition to allow the client to extend the employment of a worker presently providing services to the client.

15. An apparatus for managing time related work activities of at least one worker for at least one client, said apparatus comprising:
(a) a computer system, said computer system having a requisition module and a time track module;
(b) said requisition module being configured to track and manage procurement of labor resources, said requisition module including one or more user interfaces for allowing a client or a service provider to enter information relating to procurement of labor resources;
(c) said time track module being configured to track and manage time spent by one or more laborers including a primary timesheet approver to approve a timesheet submitted by a user; and,
(d) said time track module includes one or more user interfaces that allows a primary timesheet approver to designate one or more secondary approvers to approve timesheets should the primary timesheet approver be unable to do so.

16. An apparatus, as set forth in claim 15, wherein:
(a) said one or more user interfaces is accessible by the primary timesheet approver over the Internet.

17. An apparatus, as set forth in claim 15, wherein:
(a) said time track module is configured to automatically notify the primary timesheet approver and the one or more secondary approvers once a timesheet has been submitted for approval.

18. An apparatus, as set forth in claim 17, wherein:
(a) said time track module is configured to notify the one or more secondary approvers if the timesheet is approved by the primary timesheet approver.

19. An apparatus, as set forth in claim 15, wherein:
(a) said time track module includes one user interface that allows a primary timesheet approver to designate a plurality of secondary approvers to approve timesheets should the primary timesheet approver be unable to do so.

20. An apparatus, as set forth in claim 15, wherein:
(a) said time track module includes one user interface that allows a primary timesheet approver to designate six secondary approvers to approve timesheets should the primary timesheet approver be unable to do so.
